(19) United States
(12) Patent Application Publication
(10) Pub. No.: US 2022/0317881 A1
(43) Pub. Date: Oct. 6, 2022

(54) METHOD AND APPARATUS FOR AFFINITY BASED SMART DATA PROTECTION POLICY FOR POOLED PROTECTION TARGETS

(71) Applicant: EMC IP Holding Company LLC, Hopkinton, MA (US)

(72) Inventors: Kalyan C. Gunda, Bangalore (IN); Gururaj Kulkarni, Bangalore (IN)

(21) Appl. No.: 17/217,113

(22) Filed: Mar. 30, 2021

(51) Int. Cl. G06F 3/06

(52) U.S. Cl. CPC G06F 3/065; G06F 3/0619; G06F 3/067

(57) ABSTRACT

One example method includes configuring a data protection environment to include one or more protection targets, applying one or more tags to each of the protection targets, based on the tags, creating a pool that includes some of the protection targets, associating a rule with an SLA that specifies a dataset and a data protection requirement for the dataset, executing the rule to identify a protection target in the pool that most closely meets the data protection requirement specified by the SLA, and defining a data protection policy that includes the data protection target identified by the executing of the rule.

### FIELD OF THE INVENTION

Embodiments of the present invention generally relate to data protection. More particularly, at least some embodiments of the invention relate to systems, hardware, software, computer-readable media, and methods for affinity based smart data protection.

### BACKGROUND

Data growth and complexity is expected to present continuous challenges in the field of data protection. The so-called data explosion is a reality faced by many large-scale enterprise companies. One source has estimated that the total volume of data is expected to grow by 175ZB by 2025. The datasphere where this data is being created may be thought of as having three locations. First is the core, which includes traditional and cloud data centers, second is the edge, which includes things like remote and branch offices, and third is endpoints, which include PCs, smartphones, and Internet of Things (IoT) devices. Data continues to spread across these locations. In response, IT (Information Technology) data centers are adopting different models to handle the data, such as private, public and hybrid cloud offerings. There are various types of workloads that DP (Data Protection) software needs to protect, and these workloads may be spread across these datasphere locations. A key challenge for data protection software is to protect the critical data based on customer SLA/SLOs (Service Level Agreement/Service Level Objectives) that may vary in different data centers and other locations in the datasphere.

In light of considerations such as those noted, data protection vendors are spending significant time and energy to improve the ability of administrators to manage these massive amounts of data. The data protection policies used to protect such data typically require a certain level of intelligence to understand the customer SLAs and provide ease of implementing data protection by reducing manual effort as much as possible.

Typical data protection software protects data using statically defined policies that contain the type of workload, schedule and protection target. The protection target is mainly chosen by the backup server to protect the data in the data center, and the backup target could be on-premise or at a cloud if the data is to be stored for the long term. The protection targets, such as dedupe, cloud, or disk devices, are statically associated while defining the policies and workflows. That is, once the protection targets for storage of the data are designated, those designations may remain in force indefinitely. This is due to the fact that redesignation of a protection target may be a time consuming process.

Particularly, if a backup infrastructure is very large and includes a large number of potential protection targets for data, careful evaluation of the various protection targets is required to identify the protection target that best meets the customer demands. Designing the backup infrastructure, and evaluating the protection targets, typically requires significant effort from backup admin. With some of the enhancements in deduplication appliances such as global scale out with Federated Unified Name server (FUN server), designing of backup infrastructure becomes even more complex and time consuming as multiple options must be considered when defining data protection policies to meet customer expectations.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture and method.

FIG. 2 discloses aspects of an example method.

FIG. 3 discloses aspects of an example computing entity operable to perform any of the disclosed methods and processes.

### DETAILED DESCRIPTION OF SOME EXAMPLE EMBODIMENTS

Embodiments of the present invention generally relate to data protection. More particularly, at least some embodiments of the invention relate to systems, hardware, software, computer-readable media, and methods for affinity based smart data protection.

In more detail, some embodiments of the invention are directed to the definition and use of an affinity based backup policy. As such, example embodiments may possess various features, although no embodiment is required to implement any particular feature(s). Some embodiments may, for example, enable the definition and creation of a pool of protection targets, where each target may be suited for a different respective type of data protection workload. The protection targets may be tagged according to characteristics such as their type, model and capability. Backup policies may be defined and implemented which automatically and dynamically decide the protection target(s) best suited to meet customer SLAs that are defined within the backup policy. The customer SLAs may be assigned to particular protection policies for different types of data protection workloads. Example embodiments may also provide for the creation and use of backup policies that abstract, from administrators for example, the process of identifying the protection target that best meets the customer demands. Further, customer SLAs may have a set of rules that define the protection target to be chosen dynamically during, and as part of, a data protection process. Finally, some embodiments may help to avoid selection of sub-optimal protection targets which may adversely affect RPO (Recovery Point Objective) and/or RTO (Recovery Time Objective) times for the entity whose data is being protected.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one embodiment may enable dynamic selection and assignment of a protection target for a data protection workload. An embodiment may eliminate the need to manually review a data protection environment and assign protection targets. An embodiment may enable automatic assignment and/or re-assignment of one or more data protection targets to a data protection workload.

It is noted that embodiments of the invention, whether claimed or not, cannot be performed, practically or otherwise, in the mind of a human. As indicated by the illustrative examples disclosed herein, embodiments of the invention are applicable to, and find practical usage in, environments in which large numbers of data protection targets, such as hundreds, thousands, tens of thousands, hundreds of thousands, or more, may be managed in a data protection infrastructure. Such managing, which may comprise evaluation, assignment, and/or reassignment, of the data protection target in light of one or more expected data protection workloads, is well beyond the mental capabilities of any human to perform practically, or otherwise. Thus, while simplistic examples may be disclosed herein, those are only for the purpose of illustration and to simplify the discussion. Accordingly, nothing herein should be construed as teaching or suggesting that any aspect of any embodiment of the invention could or would be performed, practically or otherwise, in the mind of a human.

### A. Overview

Backup, or data protection, software may support various types of protection targets, depending on the particular use case(s) involved. Such protection targets generally refer to systems, devices, and other computing entities, capable of storing data, such as backup data for example. These may be referred to as protection targets since they afford protection to data by storing, for example, a copy or clone of that data. Some example protection targets that may be employed in connection with embodiments of the invention include, but are not limited to, EMC Data Domain devices (including both physical and virtual devices), non-dedupe disk storage, flash storage, private cloud object storage such as Amazon S3. Various other example storage and memory devices that may serve as protection targets are disclosed elsewhere herein.

Each of the example protection targets noted above may have different respective SLAs, performance parameters, latency, and cost. Thus, if customers have specific SLAs for data protection needs, development of static policies that statically associate protection targets with data protection workloads requires careful evaluation to meet the SLA and could adversely impact the ability to meet these SLAs if not properly designed.

To illustrate, the wrong, or sub-optimal, selection of a protection target, which may result in the protection target being over-utilized, or under-utilized, could unnecessarily delay the backup or replication window. Moreover, if a customer has various different asset types, that is, protection targets, with different respective SLA requirements for example, the customer cannot simply create a backup policy and then associate the SLA to these policies, leaving it to the backup software to automatically select a protection target depending on the SLA. Rather, the protection target selection is a time and labor intensive manual process that requires a careful designing of the backup infrastructure before protection targets can be assigned.

Consider some example data protection workloads that a customer might have to perform in a datacenter to meet one or more SLAs. Such workloads might include, for example:
Small and lower priority workloads, such as FS (Filesystem) and OS (Operating System) data;
Medium workloads with higher priority, such as VM (Virtual Machine) with FS or NDMP (Network Data Management Protocol) data; and
Large workloads with critical priority, such as mission critical applications.

Customer SLAs for protection targets may vary for different types of workloads and it may also vary in different data centers. Such SLAs might include, for example:
RPO with copies to be created with specific interval;
RTO with mission critical applications restored with low latency storage;
Performance characteristics such as faster backup/replications;
More reliable protection target with high backup success rate;
Service availability with 99.99%;
Location affinity with low latency link;
Cost associated to protect the data (cloud vs on-premise disk vs on-premise dedupe, for example); and
#Copies to be created with specific requirement for copies to be created.

Such SLAs may not only affect data backup processes, but may also affect replication processes, and restore processes, such as restoration of mission critical applications. A large enterprise backup environment may contain a significant number of heterogenous protection targets supporting the backup/replication requirements of the enterprise. Thus, backup admins can readily make significant mistakes if there is not a careful evaluation when designing the backup infrastructure for, for example, mission critical application protection having a specific associated SLA.

The following use cases are illustrative of circumstances in which affinity of data with target protection devices is not considered in the creation of a protection policy configurations, but in which consideration of such affinity, such as implemented by some example embodiments of the invention, may prove useful.

Use Case No. 1. Customer has a mixed type of workloads with regular and mission critical applications running across multiple data centers which are mainly on-premise locations. Customer wants to achieve the centralized protection by pooling the protection targets across different geographical locations and would like to define the SLA to select best protection target based on workload type and its priority. Customer has workloads spread across these data centers. Customer has SLA where customer wants to tag and protect the mission critical applications to data protection targets with less than 0.1 ms latency to these mission critical application servers. These application servers may be spread across multiple data centers with single protection policy.

Use Case No. 2. Same as Use Case No. 1, however, the customer SLA also has a replication context where the customer wants to replicate the data to different datacenters with faster and 100% reliable replication for mission critical workloads first, before regular workloads.

Use Case No. 3. Customer has mission critical applications running in a cloud computing environment, as well as at on-premise locations. The data protection policy needs to protect the applications to a protection target, or protection targets, which have a closer affinity to data residing in that location. It may be useful for the customer to take advantage of a smart and centralized protection policy by pooling the protection targets across different geographical locations for backup and replication workloads. Customer SLAs specify protection of the data within a local datacenter, and then create one or more simultaneous replication copies with one copy being replicated to one geographical location having 10-50 ms latency, and another copy being replicated to a cloud storage site having 10-100 ms latency.

### B. Aspects of Some Example Operating Environments

In general, embodiments of the invention may be implemented in connection with systems, software, and components, that individually and/or collectively implement, and/or cause the implementation of, data protection operations such as, but not limited to, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

### C. Aspects of Some Example Embodiments

In general, some example embodiments may implement an Affinity Based Backup Policy (ABBP) that may automatically select the type of storage to be used for data protection based on a defined SLA and the rules associated with that SLA. The affinity-based backup policy may abstract the user from statically associating the types of storage, while enabling a smart way of choosing the target device based on a pool of target storage devices that may each have a different respective SLA. The affinity for backup policy may include the notion of automatic selection of close proximity protection targets for various asset types, or source data, that have respective associated SLAs.

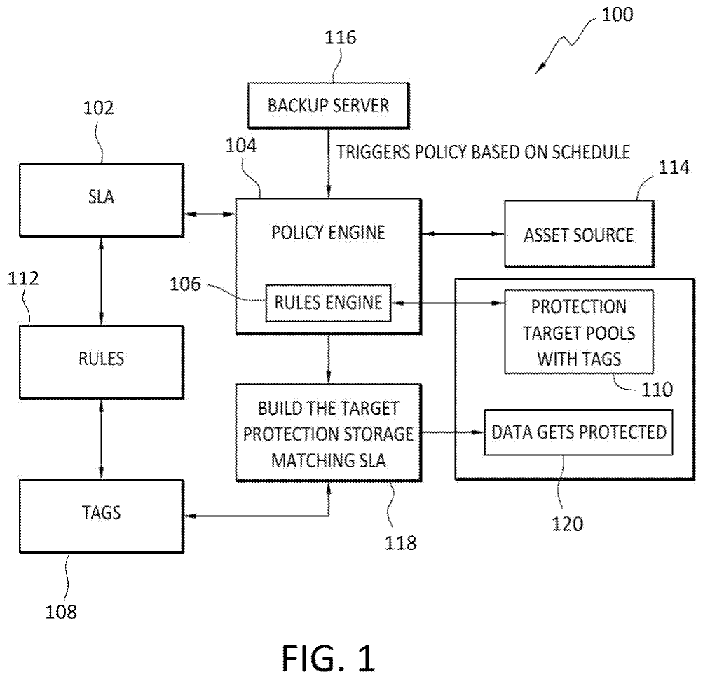

With reference now to FIG. 1, one example architecture 100 according to one or more embodiments is disclosed. The example architecture 100 may include various elements such as, but not limited to, an SLA component 102, a policy engine 104, a rules engine 106, tags 108, a protection target pool 110, and an alerting mechanism which may be part of the policy engine 104. The SLA component 102 may contain and/or generate SLAs that each include one or more rules 112. The example architecture 100 may operate to protect data generated by one or more asset sources 114, and/or other data generators. In some embodiments, any, some, or all, of the elements indicated in FIG. 1 may be included as an element of a backup server 116. Thus, although such elements are shown separately in FIG. 1, that is for the purposes of illustration and is not intended to limit the scope of the invention in any way.

In terms of its operation, the example architecture 100 may generally enable the definition and implementation 118 of target protection storage that is consistent with one or more customer SLAs. The target devices included in that implementation 118 may be drawn from the protection target pool 110, and after the target protection storage has been defined, the data of the asset sources 114 may be protected 120.

Further, embodiments of the invention may employ policies, rules, and SLAs.
POLICY: A container or other collection of information, such as a backup policy or other data protection policy, that includes, for example: identity of the source data that is to be protected; backup schedule and retention requirements for the backed up source data; identity of the SLA that applies to the source data; and, identity of the protection target where the source data is to be stored.
RULE: One or more guidelines used by an SLA component to select a particular protection target, or protection targets, based on the ability of the protection target to meet requirements imposed by the SLA. For example, a rule may specify that the protection target be located on-premise, and another rule may specify that a hard disk drive having a particular performance parameter should be used as the protection target. A protection target selected by the SLA component may be identified as part of a backup policy or other data protection policy.
SLA: Service Level Agreement between, for example, a vendor and customer. An SLA may specify customer performance requirements, for example, how many copies should be made of the source data, latency requirements, data availability requirement, RTO, and RPO. The customer may be agnostic, for example, as to which particular protection targets are used, so long as the SLA requirements are met. The requirements of the SLA may be such that the SLA may, for example, implicitly require, or rule out, certain types of protection storage.

Further details concerning individual components and their operation are set forth below.

C.1 SLA Component 102.

With reference first to the SLA component 102, this component may enable a customer to define the SLA for source data, such as from the asset sources 114, to be protected. The SLA component 102 may also store one or more SLAs. The customer may define the SLA as granularly as desired. An SLA may include, for example, parameters such as the relative priority (for example, high/medium/low) for protection of an application, the number of copies to be made of the application, RPO with a defined interval between backups, RTO for quick restore of data, latency requirement for source and target, 99.99% available, deduplication, and, cloud or on-premise storage. The SLA component 102 may receive this information from, for example, a customer by way of a graphical user interface (GUI) or command line interface (CLI) for example, and the UI or CLI may be presented by a data storage vendor to the user at a customer site.

In some cases, an SLA generated by the SLA component 102 may also include the cost factors respectively associated with different cloud storage tiers. In particular, cloud vendors may provide various different storage tier capability based on the data being accessed and specific SLA requirements. For example, if a customer SLA is for long term archive of data to a cloud storage site, then protection storage such as AWS Glacier/Azure cold storage can be chosen while tiering the data to cloud. This cold storage may be most economical in archive situation where the data is rarely, or never, accessed. As another example, if a customer SLA specifies that the customer data should be protected by storage at a cloud storage site, then further details may be added to the SLA concerning a specific cloud vendor, so that while protecting the data in accordance with the SLA, the cloud storage serves as a protection target associated with a backup/replication process for particular data generated by one or more asset sources 114.

C.2 Policy Engine 104.

The policy engine 104, which may or may not already exist depending upon the embodiment, may be associated with one or more granular SLAs. Particularly, data protection software at the backup server 116 may access the SLA to decide the type of storage to be used for protecting the workload. Thus, the SLAs may play a useful role in informing the automatic selection of protection targets during, or before, performance of data protection processes such as backup, cloning, and replication.

C.3 Rules Engine 106.

In general, one or more rules 112 may be used to design the SLAs. The rules will contain the type of storage, location of storage, latency that is expected to be used, specific model to be used, streams requirement. As more granular rules are defined, then more stringent SLAs can be created so that backup software will select the right protection storage depending on the application to be protected. As discussed below, the rules may employ tags to automatically match the protection target(s) that possibly meet the SLA criteria.

C.4 Tags 108.

Tags may be used to help to isolate the type of storage, model, accessibility, location, subnet, for example. These tags would be associated to protection storage depending on their type, location, model and accessibility so that rule engine would use to select the desired protection target based on the SLA. Some example tags that may bee employed in some embodiments include:
On-premise
Disk/Deduplication
DDVE/Physical DD
Model
Cloud/ATOS
Private S3
Flash storage
Subnet/vLAN
Location (Local, Remote, Cloud)

One or more tags may be assigned to each protection target so that the protection targets can be affiliated with each other as a group of target devices that may be selectable based on the rules within Policy SLA. For example, all protection targets that include the “Flash storage” tag may collectively form a group, or pool, of protection targets that share one or more common attributes, such as “flash storage” in this case.

Multiple tags may be assigned to a single protection target can have multiple tags associated, and a protection target may be a member of multiple different groups, or pools, of protection targets. For example, a protection target tagged with “on-premise” and “flash storage” may be a member of both the “on-premise” pool of protection targets, and the “flash storage” pool of protection targets. In some embodiments, a single pool may include protection targets that have multiple tags in common with each other. For example, a pool may include protection targets that have each been assigned the tags “flash storage,” “local,” and “disk/deduplication.”

In general, and as discussed in more detail elsewhere herein, a rule may be executed dynamically based on one or more tags to make refinements to satisfy the SLA requirement. For example, a rule that references the combination of tags “on-premise, dedupe, physical DD, model 9500” may be employed by the backup server to search a pool of protection targets to identify any protection targets with those tags that satisfy a requirement defined in the SLA. Rules may be preconfigured, or built on-the-fly, to satisfy one or more particular SLAs, and one or more rules may be included in the SLA.

Finally, data protection software, which may be running on the backup server, may automatically detect whether wrong tags are getting associated to protection storage. For example, if the tag “DDVE” is assigned to a physical disk drive (DD), the data protection software may detect the fact that a tag for a virtual device has been erroneously assigned to a physical device. The data protection software may then warn the user to avoid performing backups associated with an SLA that specifies a DDVE device, since that backup may erroneously be written to the DD instead. This information may also be used to correct the tagging so that DDVE is assigned to the correct device(s). As well, embodiments of the invention may prevent the assignment of inconsistent or contradictory tags. For example, a user may be prevented from tagging a protection target with both the tag “on-premise” and “location (cloud).”

C.5 Protection Target Pool 110.

As noted, a user may create one or more pools of storage with homogeneous storage types or mixed storage types. Each protection target in the pool may have one or more tags associated with that protection target. The tags may be used by the rules engine to select the protection storage that would match, or most closely match, requirements specified in an SLA. In some instances, multiple complementary pools may be created. For example, one pool may comprise on-premise storage assets but no offsite storage assets, while the complementary pool may comprise offsite storage assets, such as cloud protection targets, but no on-premise storage assets. As another example, one pool may include physical protection targets but no virtual protection targets, while a complementary pool may comprise virtual protection targets, but no physical protection targets. More generally, pools can be defined, implemented, and used, as needed to support one or more SLAs. As described below, protection targets and pools may be modified dynamically as conditions change in the operating environment.

C.6 Alerting Mechanism.

In a large-scale enterprise environment, there can be dynamic changes depending on customer requirements. Assets that have a specific set of SLA requirements may have their data backed up to particular storage targets. If, for example, the environment changes and/or the SLA changes, then protection target selection might also change. For example, one or more protection targets may be moved, added, or deleted. As another example, an SLA may be updated to specify a reduction in acceptable latency, such that a cloud storage protection target may no longer provide adequate performance, per the SLA, due to relatively higher latency in communicating with the cloud as compared with latency associated with an on-premise protection target. Thus, embodiments of the invention embrace an alerting mechanism, which may be an element of a policy engine, that is operable to automatically check for such changes to the SLA and environment, assess the impact, if any, on a backup policy, and alert a user to the change(s) and to the backup policy impact.

C.7 User Interfaces.

Reference is made herein to various actions that may be taken by a user, and information or other input provided to, and/or received from, a user such as a customer or administrator for example. In general, user interactions relating to example embodiments may take place by way of one or more user interfaces (UI) which may take any suitable form, examples of which include a GUI and CLI. Such a UI, or UIs, may be located at any suitable point(s) within an operating environment. Such points may include, for example, a backup server, customer site, data storage site, admin server, and a mobile phone or other mobile device.

### D. Example Methods

With continued reference to the example of FIG. 1, further details are now provided concerning operational aspects of some embodiments of the invention. In general, one example functional flow according to some embodiments may proceed as a J outlined below, although variations, additions, and omissions, to that functional flow will be apparent in view of this disclosure. The operations noted in the following discussion may be performed in the indicated order, but that is not necessarily required.

Initially, a user may configure a data protection storage environment, and associate one or more tags with each data storage asset, or protection target. These tags may be examined by the rules engine 106 to select the possible list of protection targets 110 meeting the SLA requirement. The tags may provide a granular way to classify the protection targets according to various properties, including storage type, examples of which include dedupe, cloud, disk, and the specific model of a storage device.

A user may define and implement one or more pools of protection targets, where the protection targets are each grouped in a particular pool according to one or more characteristics. For example, protection targets may be grouped together based on their type to create a pool named “on-premise protection targets” that includes all possible on-premise disk devices of various capabilities. Similarly, a user may mix protection targets of different types into the same pool. For example, the user may create a pool named “On-prem backup and LTR to Cloud.” This example pool, whose name may include characteristics of the pool devices, may contain “on-premise” disk targets as well as “cloud devices” that have Amazon S3 storage targets at different cloud providers.

The user may then configure a policy for various asset types. Such asset types may include, but are not limited to, VM (Virtual Machine), DB (Database), MSDB (Database), FS (Filesystem), NAS (Network Attached Storage).

Next, a user, such as a customer for example, may define one or more SLAs. One example SLA may specify one or more of the following parameters.
The priority of the application (that created the data) for backup
The #copies to be made of the dataset
RPO/RTO
Latency requirement
Stream requirement that would help to meet the RPO/RTO
Association of Rule

In general, an SLA may be associated with, or include, one or more rules that may aid in identifying and selecting one or more protection target(s) that match the constraints in the rule, and thus meet the requirements of the SLA. The rules can be statically defined, or may be created on the fly during SLA creation. The user may associate the rule with an SLA during creation of the backup policy, or the user may simply associate a previously created rule with the SLA. A rule may specify one or more constraints or requirements. Some examples of such constraints include:
Select protection targets that are only on-premise
Select protection target that are only physical DD
Select protection target for backup that is DD 9500 and above
Select protection target that are only cloud

A policy engine, such as the policy engine 104 for example, may associate the protection target to the asset source 114 whose data is being protected by dynamically executing the rule to identify any protection targets that meet the constraints of that rule. A rule may be dynamically executed by backup software and based on requirements of an SLA. For example, if an SLA specifies that cloud protection targets are to be used, execution of a rule that specifies “Select protection targets that are only cloud” may cause the generation of a list of possible protection targets that satisfy the SLA requirement that protection targets in the cloud be used.

In more detail, a rules engine executing a rule would search the data protection environment, and/or one or more pools, for tags associated with protection targets that may be able to satisfy a requirement of an SLA. Thus, with reference to the aforementioned example rule, the rules engine may look for protection targets tagged with “cloud.”

As another illustrative example, the rules engine may execute a rule to search for protection targets that meet the SLA requirements: “high priority application, on premise data, with at least 1 copy to be created within 4 hrs window, with 32 streams concurrently having <1 ms latency.” In this example, the backup server, which may host the rules engine, may choose the protection target based on asset priority as well as on the SLA latency requirement. Consider, for example, a case where three protection targets are identified that meet the SLA requirements, but if the application is high priority, with data to be protected with data path latency of <1 ms, then the backup server may select the protection target that most closely matches the latency requirement. No particular requirement, including a latency requirement, is mandatory for any particular policy, although in some cases, a latency requirement may help the backup server to select the best possible protection storage that meets an asset priority requirement when there are multiple protection targets that meet the SLA requirements.

Note that it may not be necessary in every case that a protection target exactly match SLA requirements. Moreover, some SLA requirements may be relatively more important than other requirements of the same SLA. For example, the SLA latency requirement may be accorded a higher priority, such as during definition/modification of the SLA, than the number of copies to be created within a particular timeframe, such that if a protection target meets the latency requirement but falls short, possibly within an acceptable margin, of the copies requirement, that protection target may still be deemed to adequately meet the SLA requirements and thus employed to back up the data specified by the SLA.

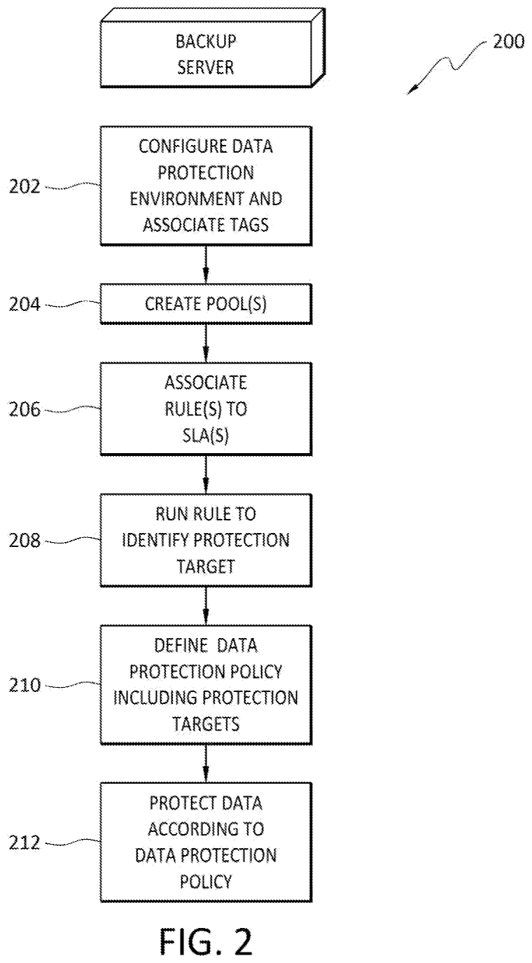

With the foregoing discussion in view, attention is directed now to FIG. 2 which discloses an example method 200 according to some embodiments. It is noted with respect to the example method of FIG. 2 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, some or all of the various processes that may make up a method may be linked together or otherwise associated with each other by way of relations such as the examples just noted.

In some implementations, the example method 200 may be performed in part, or in whole, by a backup server and/or other data protection system or device. However, it is not required that a backup server, or any other particular system or device, perform any part of the method 200. In some instances, the example method 200 may be cooperatively performed by a backup server and one or more other computing systems and/or computing devices. Some embodiments of the method 200 may involve actions by a human. For example, a user may assign tags to one or more protection targets in a data protection environment.

The example method 200 may begin when a data protection environment is configured 202. Configuration 202 of the data protection environment may involve the identification of protection targets, and other computing assets, to be included in the data protection environment. As well, the configuring 202 may also comprise assigning one or more tags to one, some, or all, of the protection targets. Configuring 202 may be performed on an ongoing basis as protection targets are moved, changed, added to, or removed from the data protection environment.

After configuration 202, one or more pools may be defined 204. The pool definition 204 may involve the grouping together of protection targets that have one or more tags in common with each other. Any number of pools may be defined 204, and a pool may overlap with one or more other pools such that, for example, a protection target, by virtue of the tags assigned to it, may be a member of more than one pool.

One or more rules may be associated with an SLA 206. The rules may be configured to satisfy one or more requirements specified in an SLA. For example, if an SLA specifies that a data protection process is to be performed with on-premise protection targets, a rule specifying “Select protection targets that are only on-premise” may be associated 206 with the SLA. Any number and types of rules may be associated with an SLA 206. The rules may be defined by a rules engine that evaluates the SLA to determine the SLA requirements and then generates rules consistent with those requirements.

The rules may then be run, such as by execution by a rules engine for example, to identify protection targets 208 in one or more pools that meet the SLA requirements. In particular, the rules engine may examine tags of the protection targets in a pool to determine whether the tagged protection target meets an SLA requirement. For example, a protection target, such as a physical disk drive, that includes the tag “physical DD” may be identified by running a rule that specifies “Select protection targets that are only physical DD.”

The identified protection targets may be included 210 in a data protection policy that specifies data protection parameters for a dataset identified in the SLA. In addition to the protection targets, the data protection policy, one example of which is a backup policy, may contain other information, some or all of which may be specified by the SLA itself, that may be considered by a data protection server when backing up the dataset. Such other information may include, for example, how many copies to make of the dataset, when to backup the dataset, how often to back up the dataset, and any other information that specifies an aspect of the backup of the dataset. Finally, a data protection process 212 may be performed that backs up the dataset, identified in the SLA for example, according to the requirements of the data protection policy.

Part, or all, of the method 200 may be performed repeatedly on an ongoing basis. In some instances, an instance of the method 200 may be performed, possibly automatically, whenever a change occurs to an SLA, or to the data protection environment. Correspondingly, rules may be added, modified, or deleted, such as in response to changes to an SLA and/or the data protection environment. In some instances, an ML/AI (Machine Learning/Artificial Intelligence) process may be employed that evaluates a completed, or partially complete, data protection process to determine whether refinements should be made to a rule, SLA, or the data protection environment.

### E. Further Discussion

As will be apparent from this disclosure, example embodiments may, but are not required to, implement various useful functionalities. By way of example, a backup application, which may be hosted on a backup server, may operate to orchestrate the automatic selection of protection targets based on the requirements of backup SLAs. As another example, one or more embodiments may avoids selection of the wrong protection targets since protection targets are not statically associated but are selected, instead, based on parameters such as the criticality of the application that generated the data that is to be backed up. Further, an embodiment may be configured to classify protection targets with tags so that rules can execute with tags meeting the SLA criteria. An embodiment may reduce, or eliminate, manual involvement by administrators in the design of backup policies that cause the backup of data in a way that meets SLA requirements. Some embodiments may operate to avoid admin/manual errors, and an SLA and rules may be configured based on asset types and can be changed dynamically without affecting the configuration of the pool. Embodiments may reduce, or eliminate, the need to wholly redesign a backup policy when an SLA, or the data protection environment, is changed in some way. Finally, embodiments may enable a user, such as a customer, to define relatively more granular SLAs, such as by specifying particular asset types, serve to protect data by using the close affinity, and proximity, of protection targets, based on criticality of the data.

### F. Further Example Embodiments

Following are some further example embodiments of the invention. These are presented only by way of example and are not intended to limit the scope of the invention in any way.

Embodiment 1. A method, comprising: configuring a data protection environment to include a plurality of protection targets; applying one or more tags to each of the protection targets; based on the tags, creating a pool that includes some of the protection targets; associating a rule with an SLA that specifies a dataset and a data protection requirement for the dataset; executing the rule to identify a protection target in the pool that most closely meets the data protection requirement specified by the SLA; and defining a data protection policy that includes the data protection target identified by the executing of the rule.

Embodiment 2. The method as recited in embodiment 1, wherein the protection targets in the pool include a common tag.

Embodiment 3. The method as recited in any of embodiments 1-2, wherein each of the tags specifies an aspect or feature of the protection target to which that tag has been applied.

Embodiment 4. The method as recited in any of embodiments 1-3, wherein part of the method is performed by a backup server.

Embodiment 5. The method as recited in any of embodiments 1-4, wherein one of the targets in the pool also belongs to another pool.

Embodiment 6. The method as recited in any of embodiments 1-5, wherein one or more of the pool, rule, and data protection policy, are automatically updated after a change to the data protection environment is detected.

Embodiment 7. The method as recited in any of embodiments 1-6, further comprising performing, according to the data protection policy, a data protection process with respect to the dataset.

Embodiment 8. The method as recited in embodiment 7, wherein executing the rule is performed as part of performance of the data protection process.

Embodiment 9. The method as recited in any of embodiments 1-8, wherein the rule specifies, for the protection target that was identified by execution of the rule, one or more of: a storage type for that protection target; a location of that protection target; an expected latency for that protection target; and, a streams requirement of that protection target.

Embodiment 10. The method as recited in any of embodiments 1-9, wherein associating the rule with the SLA comprises adding the rule to the SLA.

Embodiment 11. A method for performing any of the operations, methods, or processes, or any portion of any of these, disclosed herein.

Embodiment 12. A computer readable storage medium having stored therein instructions that are executable by one or more hardware processors to perform operations comprising the operations of any one or more of embodiments 1-11.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

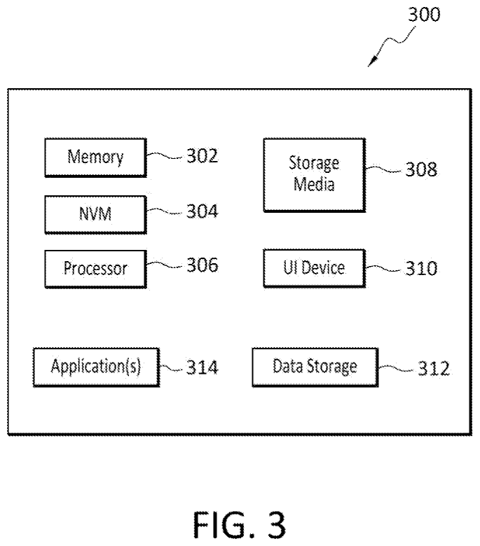

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device XXX includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
configuring a data protection environment to include a plurality of protection targets;
applying one or more tags to each of the protection targets;
based on the tags, creating a pool that includes some of the protection targets;
associating a rule with an SLA that specifies a dataset and a data protection requirement for the dataset;
executing the rule to identify a protection target in the pool that most closely meets the data protection requirement specified by the SLA; and
defining a data protection policy that includes the data protection target identified by the executing of the rule.

2. The method as recited in claim 1, wherein the protection targets in the pool include a common tag.

3. The method as recited in claim 1, wherein each of the tags specifies an aspect or feature of the protection target to which that tag has been applied.

4. The method as recited in claim 1, wherein part of the method is performed by a backup server.

5. The method as recited in claim 1, wherein one of the targets in the pool also belongs to another pool.

6. The method as recited in claim 1, wherein one or more of the pool, rule, and data protection policy, are automatically updated after a change to the data protection environment is detected.

7. The method as recited in claim 1, further comprising performing, according to the data protection policy, a data protection process with respect to the dataset.

8. The method as recited in claim 7, wherein executing the rule is performed as part of performance of the data protection process.

9. The method as recited in claim 1, wherein the rule specifies, for the protection target that was identified by execution of the rule, one or more of: a storage type for that protection target; a location of that protection target; an expected latency for that protection target; and, a streams requirement of that protection target.

10. The method as recited in claim 1, wherein associating the rule with the SLA comprises adding the rule to the SLA.

11. A computer readable storage medium having stored therein instructions that are executable by one or more hardware processors to perform operations comprising:
configuring a data protection environment to include a plurality of protection targets;
applying one or more tags to each of the protection targets;
based on the tags, creating a pool that includes some of the protection targets;
associating a rule with an SLA that specifies a dataset and a data protection requirement for the dataset;
executing the rule to identify a protection target in the pool that most closely meets the data protection requirement specified by the SLA; and
defining a data protection policy that includes the data protection target identified by the executing of the rule.

12. The computer readable storage medium as recited in claim 11, wherein the protection targets in the pool include a common tag.

13. The computer readable storage medium as recited in claim 11, wherein each of the tags specifies an aspect or feature of the protection target to which that tag has been applied.

14. The computer readable storage medium as recited in claim 11, wherein part of the computer readable storage medium is performed by a backup server.

15. The computer readable storage medium as recited in claim 11, wherein one of the targets in the pool also belongs to another pool.

16. The computer readable storage medium as recited in claim 11, wherein one or more of the pool, rule, and data protection policy, are automatically updated after a change to the data protection environment is detected.

17. The computer readable storage medium as recited in claim 11, wherein the operations further comprise performing, according to the data protection policy, a data protection process with respect to the dataset.

18. The computer readable storage medium as recited in claim 17, wherein executing the rule is performed as part of performance of the data protection process.

19. The computer readable storage medium as recited in claim 11, wherein the rule specifies, for the protection target that was identified by execution of the rule, one or more of: a storage type for that protection target; a location of that protection target; an expected latency for that protection target; and, a streams requirement of that protection target.

20. The computer readable storage medium as recited in claim 11, wherein associating the rule with the SLA comprises adding the rule to the SLA.
